(19) United States
(12) Patent Application Publication
(10) Pub. No.: US 2007/0178339 A1
(43) Pub. Date: Aug. 2, 2007

(54) PARAFFINIC HYDROCARBON FOR FUEL CELL APPLICATION

(75) Inventor: Robert Freerks, Jenks, OK (US)

Correspondence Address: BAKER & MCKENZIE LLP, Pennzoil Place, South Tower, 711 Louisiana, Suite 3400, HOUSTON, TX, 77002-2716, US

(73) Assignee: SYNTROLEUM CORPORATION, TULSA, OK (US)

(21) Appl. No.: 11/669,988

(22) Filed: Feb. 1, 2007

Related U.S. Application Data
(60) Provisional application No. 60/764,658, filed on Feb. 2, 2006.

(51) Int. Cl. H01M 8/06

(52) U.S. Cl. 429/17; 429/19

(57) ABSTRACT

A fuel cell system and a method of producing electricity in a fuel cell are described. The fuel cell system includes a reformer for converting an unreformed fuel to produce a reformate fuel gas; and a fuel cell stack adapted to generate electricity using the reformate fuel gas. The unreformed fuel is a solid paraffinic hydrocarbon. Some hydrocarbons include at least about 5 wt. percent olefins; at least about 5 wt. percent n-paraffins; and between about 2 and 50 wt. percent branched paraffins wherein substantially all of the branch groups are monomethyl and wherein the ratio of terminal monomethyl branching to internal monomethyl branching is at least about 1:1.5.

### CROSS REFERENCE TO RELATED APPLICATIONS

This application claims priority to U.S. Provisional Application Ser. No. 60/764,658, filed on Feb. 2, 2006, which is incorporated herein in its entirety.

### FEDERALLY SPONSORED RESEARCH

Not applicable.

### REFERENCE TO MICROFICHE APPENDIX

Not applicable.

### FIELD OF THE INVENTION

The present invention relates to fuel cells and methods of generating electricity in fuel cells that use fuels having improved biodegradability. More particularly, the embodiments of the invention relate to fuel cells wherein the fuel is a product derived from a Fischer-Tropsch synthesis.

### BACKGROUND OF THE INVENTION

A fuel cell is an electrochemical cell that can convert the chemical energy formed as a result of a reaction between a fuel and an oxidant to electrical energy. Fuel cells can be highly efficient and the emission levels of these cells can be considerably lower than those of conventional combustion engines.

In a fuel cell, a fuel and an oxidant combine electrochemically without combustion to produce the electrical energy. As long as the cell is supplied with fuel and oxidant, electrical power can be obtained. One fuel for use in a fuel cell is hydrogen. When hydrogen is used as the fuel, air (oxygen) is normally used as the oxidant. High purity hydrogen suitable for direct use in fuel cells is currently expensive. And, a large percentage of the potential energy of the hydrogen is lost when it is liquefied. In addition, using hydrogen gas directly requires a large distribution infrastructure, which is capitally intensive.

Consequently, alternative sources of hydrogen that do not necessarily require storing large volumes of hydrogen gas or a large distribution network are being sought. Hydrogen for use as fuel in a fuel cell can be produced internally from hydrocarbons such as natural gas, methanol, diesel, gasoline and other fuels. This is typically achieved in a fuel cell system through the use of a reformer, which reforms hydrocarbon feedstocks to produce hydrogen and carbon monoxide. Some fuel cell systems require an additional shift reaction to convert the carbon monoxide, which can be detrimental to the functioning of the fuel cell, to carbon dioxide.

One area where hydrocarbon-based fuel cells show particular promise is in the area of portable power applications. Typical uses might include portable electronics like laptop computers, cellular phones, or even hearing aids. One particularly important portable power application is in the area of personal power modules for military personnel. Personal power modules are used for devices ranging from night vision goggles to global positioning satellite units. Fuel sources for such power modules should be non-flammable and non-explosive while being desirably light weight, relatively compact, and safe to carry. Using gaseous hydrocarbon sources as fuel typically requires large volumes and containers that are too heavy for easy use, especially for personal power modules. When liquid hydrocarbon fuel sources are also used, spillage can be difficult to avoid and, as when gaseous fuel sources are used, require heavy durable containers. Another consideration in any application is its impact on the environment. Consequently, an environmentally friendly fuel that is a solid at normal temperatures would find use in fuel cell systems, especially those fuel cell systems designed for portable applications such as personal power modules.

### SUMMARY OF THE INVENTION

Embodiments of the invention provide a fuel cell that includes a reformer for converting an unreformed fuel to produce a reformate fuel gas and a fuel cell stack adapted to generate electricity using the reformate fuel gas. The unreformed fuel is a solid paraffinic hydrocarbon at ambient temperatures.

One particularly useful hydrocarbon comprises at least about 5 wt. percent olefins; at least about 5 wt. percent n-paraffins; and between about 2 and 50 wt. percent branched paraffins wherein substantially all of the branch groups are monomethyl and wherein the ratio of terminal monomethyl branching to internal monomethyl branching is at least about 1:1.5.

In other embodiments, the invention provides a method of producing electricity in a fuel cell. Such methods include converting an unreformed fuel to produce a reformate fuel gas; and electrochemically combining hydrogen derived from said reformate fuel gas with an oxidant without combustion to produce electrical energy, wherein the unreformed fuel comprises at least about 5 wt. percent olefins; at least about 5 wt. percent n-paraffins; and between about 2 and 50 wt. percent branched paraffins wherein substantially all of the branch groups are monomethyl and wherein the ratio of terminal monomethyl branching to internal monomethyl branching is at least about 1:1.5.

In some embodiments, the ratio of terminal monomethyl branching to internal monomethyl branching in the unreformed fuel is at least about 1:1. In some fuels, the n-paraffins are present in an amount of at least about 20 wt. percent and the ratio of terminal monomethyl branching to internal monomethyl branching is at least about 1.5:1. In other fuels, the n-paraffins are present in an amount of at least about 40 wt. percent and the ratio of terminal monomethyl branching to internal monomethyl is at least about 2:1. While any fuel having such characteristics may be used, some unreformed fuels are a product of a Fischer-Tropsch reaction. Any Fischer-Tropsch process may be used provided the recited branching characteristics are present in the fuel. One suitable Fischer-Tropsch reaction incorporates feed syngas having 10-60% N₂. In some embodiments, the fuel is a solid at a temperature in the range of about 20° C. to about 50° C.

Certain fuel cells can also include a carbon monoxide shift unit. Carbon monoxide shift units are typically incorporated where a catalyst in the fuel cell is sensitive to the presence of carbon monoxide.

In one particular embodiment, the fuel cell system includes a reformer for converting an unreformed fuel to produce a reformate fuel gas; and a fuel cell stack adapted to generate power using the reformate fuel gas. The unreformed fuel is a solid at a temperature ranging from 20° C. to about 50° C. and comprises at least about 5 wt. percent olefins; at least about 5 wt. percent n-paraffins; and between about 2 and 50 wt. percent branched paraffins wherein substantially all of the branch groups are monomethyl and wherein the ratio of terminal monomethyl branching to internal monomethyl branching is at least about 1:1.5; and is a product of a Fischer-Tropsch reaction that incorporates feed syngas having 10-60% N₂.

In another particular embodiment, the invention provides a method of producing electricity in a fuel cell wherein the method includes providing a solid paraffinic hydrocarbon fuel, b) converting said solid paraffinic hydrocarbon fuel to a liquid, a gas, or a mixture thereof, c) passing said liquid, gas or mixture thereof through a reformer to produce hydrogen; and d) electrochemically combining the hydrogen with an oxidant to produce electrical energy; wherein the unreformed fuel comprises at least about 5 wt. percent olefins; at least about 5 wt. percent n-paraffins; and between about 2 and 50 wt. percent branched paraffins wherein substantially all of the branch groups are monomethyl and wherein the ratio of terminal monomethyl branching to internal monomethyl branching is at least about 1:1.5.

### BRIEF DESCRIPTION OF THE DRAWINGS

FIG. 1 is a schematic illustration of a fuel cell assembly according to an embodiment of the invention.

### DESCRIPTION OF EMBODIMENTS OF THE INVENTION

In the following description, all numbers disclosed herein are approximate values, regardless whether the word “about” or “approximate” is used in connection therewith. They may vary by 1%, 2%, 5%, and sometimes, 10 to 20%. Whenever a numerical range with a lower limit, R^{L} and an upper limit, R^{U}, is disclosed, any number falling within the range is specifically disclosed. In particular, the following numbers within the range are specifically disclosed: R=R^{L}+k*(R^{U}−R^{L}), wherein k is a variable ranging from 1% to 100% with a 1% increment, i.e., k is 1%, 2%, 3%, 4%, 5%, . . . , 50%, 51%, 52%, . . . , 95%, 96%, 97%, 98%, 99%, or 100%. Moreover, any numerical range defined by two R numbers as defined in the above is also specifically disclosed.

Unless otherwise specified, all quantities, percentages and ratios herein are by weight.

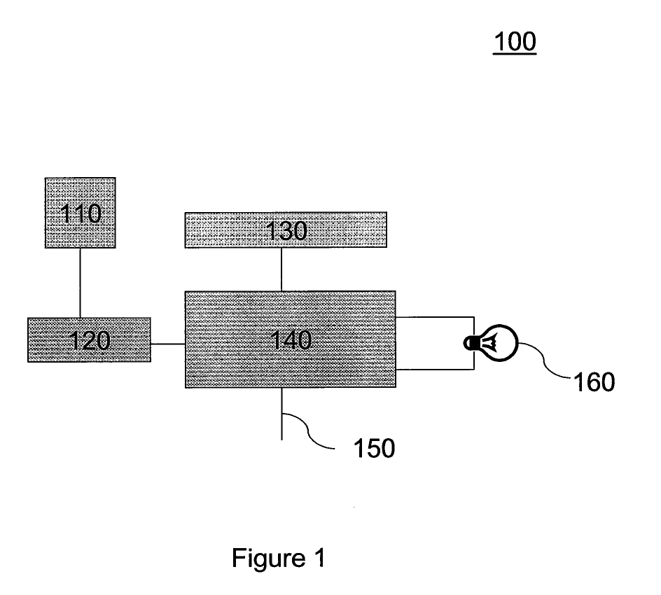

FIG. 1 schematically illustrates an embodiment of a fuel cell assembly 100. Fuel cell assembly 100 includes a fuel reservoir 110. Fuel reservoir 110 typically also includes a heater or other means for moving the fuel to the reformer 120. Reformer 120 converts at least a portion of the fuel to a reformate gas, typically hydrogen. Other products of the reformer can include carbon monoxide, carbon dioxide, and other hydrocarbons. Examples of reformers are provided in U.S. Pat. Nos. 5,616,430, 5,733,675, and 6,329,091. Fuel cell assembly 100 also includes an oxidant reservoir 130. Typically, the oxidant reservoir stored oxygen, however, any oxygen may be selected so long as it is capable of oxidizing the reformate gas produced by the reformer. The oxidizer and the reformate gas are passed into a fuel cell 140. While FIG. 1 shows that the oxidant and reformate gas enter the fuel cell through separate conduits, they may also be combined into one stream before entering the fuel cell 140. The fuel cell 140 may be of any currently known or later discovered design so long as it is capable of converting the reformate gas and the oxidant to electrical energy. Fuel cell design is well known and described in Fuel Cell Technology Handbook (1^{st} ed. 2002), published by CRC Press, Inc, incorporated herein by reference in its entirety. The fuel cell 140 typically also includes an exhaust port 150 through which the reaction products pass. Typically, the products of the reaction are water and carbon monoxide. Some embodiments, particularly those that include a component, such as a catalyst, that is adversely affected by carbon monoxide, also include a shift unit (not shown). Shift units are well-known and are used to convert at least a portion of the carbon monoxide to carbon dioxide. Consequently, the shift unit, when used, should be located so that the products of the reformer pass through the shift unit before reaching the fuel cell 140. In some embodiments the exhaust port 150 is connected to a recycle unit (not shown). Such recycle units are known in the art and are used to convert at least a portion of the products, such as water, carbon monoxide, and carbon dioxide, back into species that can be passed through the fuel cell to produce electricity. The electricity produced by the fuel cell can be used to operate any number of electrical devices, schematically represented as the load 160 in FIG. 1.

The fuel cell assemblies described herein employ a fuel that is a solid at ambient temperatures. Consequently, the handling and storage of the fuel is much easier than if the fuel were a liquid or gaseous hydrocarbon. Some particularly useful fuels are those comprising from about 5 to about 90 wt. percent linear alpha- and internal olefins, from about 5 to about 20 wt. percent isoparaffins, from about 5 to about 90 wt. percent n-paraffins and from about 0 to about 10 wt. percent oxygenates. In some embodiments, the fuel may be obtained from a Fischer-Tropsch synthesis using synthesis gas as a feed stock. Moreover, production of the fuel from a fuel produced by the Fischer-Tropsch synthesis and subsequent processing as described herein is especially desirable as it results in a product having the desirable olefin and paraffin contents. But, the fuel composition need not be produced by a Fischer-Tropsch process. Any process that results in the particular fuel composition is suitable.

Fischer-Tropsch processes convert synthesis gas, or syngas, into hydrocarbons. Three basic techniques may be employed for producing syngas for use as the starting material of a Fischer-Tropsch reaction. These include oxidation, reforming and autothermal reforming. As an example, a Fischer-Tropsch conversion system for converting hydrocarbon gases to liquid or solid hydrocarbon products includes a synthesis gas unit, which includes a synthesis gas reactor in the form of an autothermal reforming reactor (ATR) containing a reforming catalyst, such as a nickel-containing catalyst. A stream of light hydrocarbons to be converted, which may include natural gas, is introduced into the reactor along with oxygen (O₂). The oxygen may be provided from compressed air or other compressed oxygen-containing gas, or may be a pure oxygen stream. The ATR reaction may be adiabatic, with no heat being added or removed from the reactor other than from the feeds and the heat of reaction. The reaction is carried out under sub-stoichiometric conditions whereby the oxygen/steam/gas mixture is converted to syngas. Examples of Fischer-Tropsch systems are described in U.S. Pat. Nos. 4,973,453; 5,733,941; 5,861,441; 6,130,259, 6,169,120 and 6,172,124, the disclosures of which are herein incorporated by reference.

The Fischer-Tropsch reaction for converting syngas, which is composed primarily of carbon monoxide (CO) and hydrogen gas (H₂) may be characterized by the following general reaction:

2nH₂+nCO→(—CH₂—)ₙ+nH₂O (1)

Non-reactive components, such as nitrogen, may also be included or mixed with the syngas. This may occur in those instances where air or some other non-pure oxygen source is used during the syngas formation.

The syngas is delivered to a synthesis unit, which includes a Fischer-Tropsch reactor (FTR) containing a Fischer-Tropsch catalyst. Numerous Fischer-Tropsch catalysts may be used in carrying out the reaction. These include cobalt, iron, ruthenium as well as other Group VIIIB transition metals or combinations of such metals, to prepare both saturated and unsaturated hydrocarbons. For purposes of this invention, a non-iron catalyst may be used. The F-T catalyst may include a support, such as a metal-oxide support, including silica, alumina, silica-alumina or titanium oxides. For the purposes of this reaction, a cobalt catalyst on transition alumina with a surface area of approximately 100-200 m²/g is used in the form of spheres of 50-150 μm in diameter. The cobalt concentration on the support may also be 15-30%. Certain catalyst promoters and stabilizers may be used. The stabilizers include Group IIA or Group IIIB metals, while the promoters may include elements from Group VIII or Group VIIB. The Fischer-Tropsch catalyst and reaction conditions may be selected to be optimal for desired reaction products, such as for hydrocarbons of certain chain lengths or number of carbon atoms. Any of the following reactor configurations may be employed for Fischer-Tropsch synthesis: fixed bed, slurry reactor, ebullating bed, fluidizing bed, or continuously stirred tank reactor (CSTR). For the purposes of this reaction, a slurry bed reactor is used. The FTR may be operated at a pressure of 100 to 500 psia and a temperature of 375° F. to 500° C. The reactor gas hourly space velocity (“GHSV”) may be from 1000 to 8000 hr⁻¹. Syngas useful in producing a Fischer-Tropsch product useful in the invention may contain gaseous hydrocarbons, hydrogen, carbon monoxide and nitrogen with H₂/CO ratios from about 1.8 to about 2.4. A detailed description of the Fischer-Tropsch reaction and reaction conditions useful in producing the fuel is contained in co-pending, commonly-owned U.S. Pat. No. 6,939,999 entitled “Integrated Fischer-Tropsch Process with Improved Alcohol Processing Capability” and listing Armen Abazajian as inventor, the disclosure of which is incorporated in its entirety herein by reference. The hydrocarbon products derived from the Fischer-Tropsch reaction may range from methane (CH₄) to high molecular weight paraffinic waxes containing more than 100 carbon atoms. Typically, the fuels used in the fuel cells herein have 18 to 100 carbon atoms. Large concentrations of components having fewer numbers of carbons should be avoided where their presence causes the fuel to have an undesirably low melting point.

One particular fuel is described in U.S. application Ser. No. 10/785,317, filed on Feb. 24, 2004, incorporated herein by reference in its entirety. Fuels prepared according to the procedure described therein have improved lubricity, lower toxicity, and improved biodegradability. While they tend to be lower in molecular weight, the process described therein can be altered to provide higher molecular weight products while retaining the desired properties.

Desired properties of some fuels are related to particular components in the fuels. Typical fuels contain from about 5 to about 90 wt. percent linear alpha- and internal olefins. The olefin content may provide the mixture with lower pour-point, better surface activity, better lubricity and better adherence to metal. When the fuel is produced from the Fischer-Tropsch synthesis with the appropriate Fischer-Tropsch catalyst and operating conditions, the Fischer-Tropsch product will have approximately 5% alpha and internal olefin content. Depending upon the reaction conditions of the FTR and catalyst used in the Fischer-Tropsch reaction, it may be necessary to concentrate the olefin content to achieve higher percentages of olefins in the fuel. Concentration of olefins may be done, for example, by one or more of the following known techniques: (1) molecular sieve separation of olefins and paraffins, such as UOP's Olex® process, and (2) distillation of paraffins away from individual C# cuts.

The fuel may contain between about 5 to about 95 wt. percent paraffins. Of the total paraffin content from about 3 to about 20 wt. percent are isoparaffins. Substantially all of the isoparaffins are terminal monomethyl species. For the purposes of this invention, the terminal species are 2-, 3-, 4-, and 5-methyl branched. The presence of monomethyl isoparaffins improves low temperature properties, such as pour point, as well as lubricity and viscosity. Moreover, because the isoparaffins are predominately terminally branched, the paraffin content of the fuel is substantially wholly biodegradable. Using the Fischer-Tropsch synthesis described herein, about 5 wt. percent terminal methyl branched paraffins are produced in the LFTL.

Concentration of isoparaffins may be increased by one or more of the following techniques: (1) molecular sieve separation of linear and branched paraffins, such as UOP's Molex® process, and (2) isomeric distillation of isoparaffin as described in co-pending commonly owned U.S. application Ser. No. 10/427,138, filed on Apr. 30, 2003, entitled “Hydrocarbon Products and Methods of Preparing Hydrocarbon Products” listing Armen Abazajian as inventor.

The oxygenates in the fuel are principally primary alcohols. Aldehydes, ketones, carboxylic acids and esters and di-esters of carboxylic acids are present in small amounts. Oxygenate content in the Fischer-Tropsch reaction product ranges from between about 0.5 to about 5.0 wt. percent. Low levels of oxygenates in the fuel from between about 0 and about 10 wt. percent provides improved lubricity.

Oxygenate control may be used on the Fischer-Tropsch product stream. In one embodiment of the invention, a fuel is produced by vaporizing the FT product stream and passing the vaporized product over an activated alumina catalyst to dehydrate alcohols to corresponding olefins. This process is described in detail in the previously incorporated U.S. Application entitled “Integrated Improved Fischer-Tropsch Process with Enhanced Oxygenates Processing Capability.” The conversion of the alcohol content of the product stream occurs according to the following reaction:

CH₃—(CH₂)ₓ—CH₂—CH₂OH→CH₃—(CH₂)ₓ—CH═CH₂+H₂O (2)

Following dehydration, the aqueous and organic phases may be separated. Such dehydration process may further be used to increase the olefin content of the product stream to be used to produce the fuel.

Other methods of oxygenate control include, for example, reaction of the alcohol content of the Fischer-Tropsch product stream with maleic or succinic anhydride or with a carboxylic acid, such as formic acid, acetic acid, or other acids. The carboxylic acid esters may be retained in the stream as they are excellent lubricants which are also highly biodegradable. Both the lubricity and the biodegradability of the fuel may be improved by converting at least a portion of the alcoholic oxygenate content to carboxylic acid esters.

The fuel may optionally include one or more surfactants (e.g., emulsifiers, wetting agents), viscosifiers, weighting agents, fluid loss control agents, and proppants. Because the fuel should be non-toxic, these optional ingredients, like the fuel, are preferably also non-toxic. Acceptable emulsifiers include, but are not limited to, fatty acids, and fatty acid derivatives including amido-amines, polyamides, polyamines, esters, imidaxiolines, and alcohols. Typical wetting agents include, but are not limited to, lecithin, fatty acids, crude tall oil, oxidized crude tall oil, organic phosphate esters, modified imidazolines, modified amidoamines, alkyl aromatic sulfates, alkyl aromatic sulfonates, and organic esters of polyhydric alcohols. Exemplary weighting agents include, but are not limited to, barite, iron oxide, gelana, siderite, calcium oxide, and calcium carbonate. Acceptable proppants include sand, gravel, and nut shells. Exemplary viscosifiers include, but are not limited to, organophilic clays, non-organophilic clays, oil soluble polymers, polyamide resins, and polycarboxylic acids and soaps. Illustrative fluid loss control agents include, but are not limited to, asphaltics (e.g., asphaltenes and sulfonated asphaltenes), modified lignites, and polymers, such as polystyrene, polybutadiene, polyethylene, polypropylene, polybutylene, polyisoprene, natural rubber, and butyl rubber. Where additives are used in the fuel, the fuel constitutes from about 25 to about 85 volume percent of the total fuel.

While the invention has been described with respect to a limited number of embodiments, the specific features of one embodiment should not be attributed to other embodiments of the invention. No single embodiment is representative of all aspects of the inventions. Moreover, variations and modifications therefrom exist. For example, the fuel compositions described herein may comprise other components. Various additives may also be used to further enhance one or more properties. In some embodiments, the composition is substantially free of any component or additive not specifically enumerated herein. Some embodiments consist of or consist essentially of the components specifically recited in the examples above or recited in the claims below. In addition, some fuels have high lubricity, which can be useful where clogging or flow problems are encountered. Some fuels are low toxicity. Thus, they can be handled with reduced risk of harm to the user, particularly military personnel who may be handling the fuel in extreme or high-stress conditions. Moreover, some fuels used in the fuel cell assemblies described herein are biodegradable. Consequently, their widespread use and accidental release should be less harmful to the environment, thereby providing an alternative to processes and products that can produce electricity, but rely on traditional sources of fuel. While the devices and methods described herein have been discussed with respect to personal power modules, the same principles and features can be applied to large scale production of electricity. Such uses might include fuel cell assemblies that use the fuels described herein to generate electricity for single- or multiple-family dwellings, factories, refineries, or any number of other activities. The appended claims intend to cover all such variations and modifications as falling within the scope of the invention.

I claim:

1. An apparatus for producing electricity, comprising:
a) a reformer for converting an unreformed fuel to a reformate fuel gas; and
b) a fuel cell stack adapted to generate electricity using the reformate fuel gas;
wherein the unreformed fuel is a solid paraffin hydrocarbon at ambient temperatures.

2. The apparatus of claim 1, wherein the unreformed fuel comprises at least about 5 wt. percent olefins; at least about 5 wt. percent n-paraffins; and between about 2 and 50 wt. percent branched paraffins wherein substantially all of the branch groups are monomethyl and wherein the ratio of terminal monomethyl branching to internal monomethyl branching is at least about 1:1.5.

3. The fuel cell of claim 2 wherein the ratio of terminal monomethyl branching to internal monomethyl branching is at least about 1:1.

4. The fuel cell of claim 2 wherein the n-paraffins are present in an amount of at least about 20 wt. percent and wherein the ratio of terminal monomethyl branching to internal monomethyl branching is at least about 1.5:1.

5. The fuel cell of claim 2 wherein the n-paraffins are present in an amount of at least about 40 wt. percent and wherein the ratio of terminal monomethyl branching to internal monomethyl is at least about 2:1.

6. The fuel cell of claim 1 wherein the unreformed fuel is a product of a Fischer-Tropsch reaction.

7. The fuel cell of claim 6 wherein the Fischer-Tropsch reaction incorporates feed syngas having 10-60% N₂.

8. The fuel cell according to claim 1, further including a carbon monoxide shift unit.

9. The fuel cell according to claim 1, wherein the fuel is a solid at a temperature in the range of about 20° C. to about 50° C.

10. A method of producing electricity in a fuel cell, comprising:
a) converting an unreformed fuel to a reformate fuel gas; and
b) electrochemically combining hydrogen derived from said reformate fuel gas with an oxidant without combustion to produce electrical energy;
wherein the unreformed fuel is a solid paraffin hydrocarbon at ambient temperatures.

11. The method of claim 10, wherein the unreformed fuel comprises at least about 5 wt. percent olefins; at least about 5 wt. percent n-paraffins; and between about 2 and 50 wt. percent branched paraffins wherein substantially all of the branch groups are monomethyl and wherein the ratio of terminal monomethyl branching to internal monomethyl branching is at least about 1:1.5.

12. The method of claim 11 wherein the ratio of terminal monomethyl branching to internal monomethyl branching is at least about 1:1.

13. The method of claim 11 wherein the n-paraffins are present in an amount of at least about 20 wt. percent and wherein the ratio of terminal monomethyl branching to internal monomethyl branching is at least about 1.5:1.

14. The method of claim 11 wherein the n-paraffins are present in an amount of at least about 40 wt. percent and wherein the ratio of terminal monomethyl branching to internal monomethyl is at least about 2:1.

15. The method of claim 11 wherein the unreformed fuel is a product of a Fischer-Tropsch reaction.

16. The method of claim 15 wherein the Fischer-Tropsch reaction incorporates feed syngas having 10-60% N₂.

17. The method according to claim 10, further including a carbon monoxide shift unit.

18. The method according to claim 10, wherein the fuel is a solid at a temperature in the range of about 20° C. to about 50° C.

19. A fuel cell system comprising:
a) a reformer for converting an unreformed fuel to a reformate fuel gas; and
b) a fuel cell stack adapted to generate power using the reformate fuel gas;
wherein the unreformed fuel comprises at least about 5 wt. percent olefins; at least about 5 wt. percent n-paraffins; and between about 2 and 50 wt. percent branched paraffins wherein substantially all of the branch groups are monomethyl and wherein the ratio of terminal monomethyl branching to internal monomethyl branching is at least about 1:1.5;
wherein the unreformed fuel is a solid at a temperature in the range of from about 20° C. to about 50° C.
wherein the unreformed fuel is a product of a Fischer-Tropsch reaction that incorporates feed syngas having 10-60% N₂.

20. A method of producing electricity in a fuel cell, comprising:
a) providing a solid paraffinic hydrocarbon fuel;
b) converting said solid paraffinic hydrocarbon fuel to a liquid, a gas, or a mixture thereof;
c) passing said liquid, gas or mixture thereof through a reformer to produce hydrogen; and
d) electrochemically combining the hydrogen with an oxidant to produce electrical energy;
wherein the unreformed fuel comprises at least about 5 wt. percent olefins; at least about 5 wt. percent n-paraffins; and between about 2 and 50 wt. percent branched paraffins wherein substantially all of the branch groups are monomethyl and wherein the ratio of terminal monomethyl branching to internal monomethyl branching is at least about 1:1.5.
